(19) United States
(12) Patent Application Publication
(10) Pub. No.: US 2024/0311452 A1
(43) Pub. Date: Sep. 19, 2024

(54) SYSTEMS AND METHOD TO QUANTIFY PERSONAL IDENTITY CONFIDENCE SCORES AND AUTHENTICATION METRICS IN SMARTPHONE AND IOT DEVICE DATA

(71) Applicant: Robert S. Buller, JR., Mount Pleasant, SC (US)

(72) Inventor: Robert S. Buller, JR., Mount Pleasant, SC (US)

(21) Appl. No.: 18/121,801

(22) Filed: Mar. 15, 2023

Related U.S. Application Data
(60) Provisional application No. 63/321,271, filed on Mar. 18, 2022.

(51) Int. Cl. G06F 21/31

(52) U.S. Cl. CPC G06F 21/31

(57) ABSTRACT

Embodiments of the present disclosure relates generally to advanced analytical methods and the software that is applied to certain input data, and, more particularly, to advanced analytical methods-such as artificial intelligence- and the software that is applied to data consisting of varied smartphone and peripheral device data by users-interacting either actively or passively with their smartphone and/or additional or peripheral Internet of Things (“IoT”) devices to create an Artificial Intelligence-generated, Dynamic, Credentialling (AIDC) in order to enable more secure and automated authentications into computer systems, televisions, applications, any internet-of-things device and/or networks. The AIDC generates a Personal Confidence Score (PCS) identifying the user and the user's authenticity level.

### CROSS-REFERENCE TO RELATED APPLICATIONS

The present application claims the benefit of U.S. Provisional Application Ser. No. 63/321,271, filed Mar. 18, 2022, having the same title, and which is incorporated herein by this reference.

### BRIEF DESCRIPTION OF DRAWINGS

FIG. 1 is an example flow chart illustrating aspects of system functionality, in accordance with some embodiments of the present disclosure.

FIG. 2 is a view of a simplified iterative process flow for the ACSAMF, according to some embodiments of the present disclosure.

FIG. 3 is a detailed view of an example mobile application device connection page, where, according to some embodiments of the present disclosure, information such as the user's mobile telephone number is input to connect the smartphone to the ACSAMF.

FIG. 4 is an example interface present in some embodiments of the present disclosure that depicts the verification code input and re-send request to verify the device for the ACSAMF.

FIG. 5 is an example “Verify with QR Code” interface, according to some embodiments of the present disclosure, showing simple instructions to open the device's camera application to scan the appropriate code to allow access to another device and/or verify the user through certain methods in the ACSAMF.

FIG. 6 shows an “Email Verification” mobile application interface which further illustrates the user verification mechanisms (MFA), according to some embodiments of the present disclosure.

FIG. 7 shows a depiction of the main Pahu Mobile Application homepage, showing a time-based personal greeting, potential Boost points available, the interaction wheel with personalized “Pahu-score” or PCS, security lock slider and additional options to Boost or “Pahu-In” options, according to some embodiments of the present disclosure.

FIG. 8 is a view of the “Biometric Boost” preliminary interface, showing user instructions and an option to enact a biometric scan in the form of an on-device fingerprint reading, according to some embodiments of the present disclosure.

FIG. 9 is a view of an alternate “Biometric Boost” preliminary interface, showing user instructions and an option to enact a biometric scan in the form of an on-device face scan reading, according to some embodiments of the present disclosure.

FIG. 10 is an example display of the “Friends” interface, which enables a personalized “Pahu-score” increase based on system detection of nearby contacts, according to some embodiments of the present disclosure.

FIG. 11 shows an alternate embodiment of the “Friends” feature interface, allowing the addition of personal contacts in a manual manner.

FIG. 12 is an example interface of the same “Friends” feature depicting a pending friend Boost on behalf of the user, according to some embodiments of the present disclosure.

FIG. 13 is an example “Text Boost” interface showing the instructions, code-entry, re-send request, and code submit options necessary to receive a one-time “Text Boost”, according to some embodiments of the present disclosure.

FIG. 14 is an exemplary “Email Boost Congratulations” interface, depicting the congratulatory message, and score-Boost visualization, and “Mini Boost” with an accompanying relative “Boost Meter” to relatively show how much of a Boost was applied, according to some embodiments of the present disclosure.

FIG. 15 is an exemplary “Biometric Boost Congratulations” interface, depicting the congratulatory message, and score-Boost visualization, and “Boost” score denomination description, according to some embodiments of the present disclosure.

FIG. 16 is an additional exemplary “Biometric Boost Congratulations” interface, depicting the congratulatory message, and “Boost Meter” or score-Boost visualization, and “Super Boost” score denomination description, according to some embodiments of the present disclosure.

FIG. 17 shows a “Pahu-In” interface, showing a “Scan QR Code” option button and various reputable goods or services companies listed horizontally in the “New Pahus” section. Additionally shown is the “Pahu In” button—which executes the authentication when one or more company logos are selected.

FIG. 18 is an alternate view of the “Pahu-In” interface, showing different but similarly reputable companies in the “New Pahus” selector section with an additional “My Pahus” section with previously used Pahu connections displayed, according to some embodiments of the present disclosure.

FIG. 19 is a detailed view of the “Settings” interface of the mobile application, according to some embodiments. Shown in detail is the “Friends” component of the “Settings” interface, listing 3 friends, and 3 corresponding “Remove Friends” buttons, and an “Add A Friend” option, as well as a link to the Pahu Knowledge Center for additional user information.

FIG. 20 is a detailed “Settings” interface of the mobile application, according to some embodiments. Sections with user-information and corresponding potential actions and options are shown for “Version”, “Application Updates”, and “Notifications” sections, according to some embodiments of the present disclosure.

The patent or application file contains at least one drawing executed in color. Copies of this patent or patent application publication with color drawing(s) will be provided by the Office upon request and payment of the necessary fee.

### DETAILED DESCRIPTION OF THE DRAWINGS

The present systems and methods utilize Multi-Factor Authentication (MFA) in conjunction with a dynamic identity confidence score instead of basing its root-authentication on solely upon a Static Credential (SC). The present systems and methods differ from the current SC, as they are always-on, utilizes all-factors including environment, movement, location, time, and generally available user data from a IoT device to create an Artificial-Intelligence-generated, Dynamic, Credential (AIDC). The present system and methods utilize machine learning algorithms to then pattern users from all this combined data. The present system and methods create a score that the machine learning has learned the users' patterns and changes the score as it is matched against a user's prior patterns. This score is the Pahu Confidence Score (PCS). The PCS ranges from 1 to 100. A PCS of 90 is a reference that the Artificial Intelligence (AI) calculations show a 90-percent correlation between the current AIDC data versus past. Essentially the PCS is showing it is 90% confident that the user is the user. MFA is an additional security layer to the AIDC's. PCS significantly differs from MFA as an additional security layer on top of an SC at Point-in-Time (PiT) authentication. With the AIDC PCS the user has nothing to compromise except the IoT device itself, but if the IoT device is compromised the PCS drops precipitously because a new user of an IoT will act, move and be different than another. When factoring in time, location, and environment the new users score will differ and the anomaly detection of the IoT device will change, therefore creating lower PCSs. Relying Parties (RP) using the PCS to authenticate users will be able to use the PCS in conjunction with its authentication methodology and systems. An RP that receives a low PCS from its pre-determined thresholds may invoke MFA. By constantly scoring a user's streaming data using advanced machine learning, additional behavior and data-based anomaly detection and other enhanced security features, the presently disclosed technology represents an accurate, sophisticated user authentication model that is both significantly more secure than conventional usernames and passwords and far more simplified for use—all while utilizing the standards of cyber security, such as MFA. RPs may also utilize the AIDC PCS in conjunction with a SC by embedding the PCS Software Development kit (SDK). The PCS SDK is a small microservice embedded in any mobile application that resides on any IoT that streams AIDC-related data to the machine learning to generate a PCS. The PCS SDK returns the PCS to the RP at the PiT authentication along with its own and/or other authentication methods and systems. The PCS may be provided to the RP as many times, always, constantly or at the PIT, whatever the RP decides.

The presently disclosed systems and methods combine AIDC with Always-on Authentication (AoA) to create a dynamic authentication solution that may be called at any time and obtain a PCS, versus existing password-less solutions. The presently disclosed technology is not merely a password-less authentication solution, as it is AoA; always-on, always-authenticating, applying the combination of machine learning, and advanced methods to create a dynamic ‘credential’ for the user to utilize upon authentication request, the AIDC.

Furthermore, embodiments of the present systems and methods encompass the practice of continual training of the machine learning models to provide a continually updating machine learning basis which describes the user in this data space. Plainly stated, the longer Pahu performs its AIDC the better it gets in identifying the user. Just like in the human world, as we get to know someone better, we are better able to predict their behavior. Within the digital world it takes moments for the machine learning to understand the user and in just days it could be the equivalent to years in knowing a person. The AIDC is created, over time, of up to billions of points of data on the user, versus todays leading user data authentication method, the biometric (Face ID for purposes of this example). The Facial ID may consist of 30,000 or more data points of a user's face, of which when a biometric identifies a user from the Face ID, it is never 100% match. Instead, the Face ID matches within acceptable ranges, e.g., 20,000 points matched so it is a match. In other words, the Face ID generates a 70% or 90% match of the biometric; never 100%. These systems and methods perform a similar match of a user, but not just their face, their environment, the time, the location, the movement and torque and other factors outside of just the person. It uses machine learning to generate the PCS, the equivalent of a biometric ID recognition match, for the purposes of authentication.

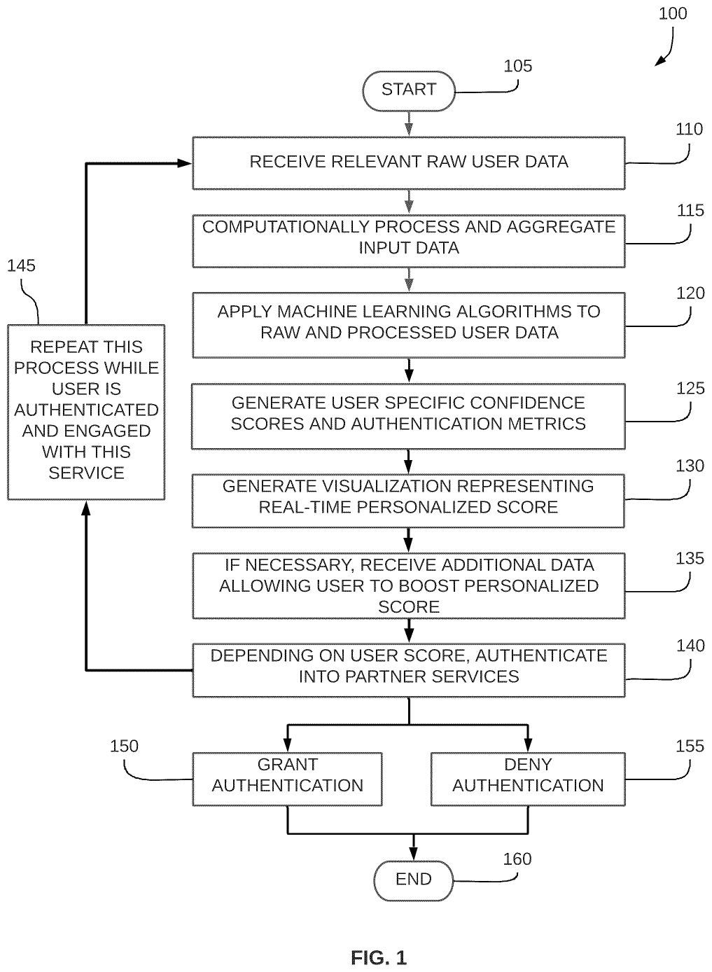

FIG. 1 is a view of a simplified process flow, according to some embodiments of the present disclosure. In one embodiment 100, the process starts 105 with the receipt of the relevant user data 110 by the Automated Confidence Score and Authentication Metrics Framework, (“ACSAMF”). According to some embodiments, this input dataset contains raw smartphone and/or peripheral device information. It is to be understood by someone skilled in the art that peripheral data may be associated with additional devices either connected by Bluetooth technology or similar ad-hoc wireless network and may include personal fitness devices, smartwatches, audio speakers, TVs, styluses, or other smartphones. This data is of a nature related to movement, location, phone status or connection state with potentially additional devices, atmospheric weather conditions, geomagnetic force, digital biometric data, and/or behavioral. The purpose of the per-user authentication metrics and personal confidence score is to enable a novel, seamless and secure authentication. The systems and methods employ the use of streamed smartphone telemetry and sensor data to cloud-based AI or locally stored AI. Examples included, but are not limited to data from a magnetometer, gyroscope, pressure, temperature, accelerometer, gravity, longitude, latitude, geomagnetic force. This data, which may be processed to optimize the economics of data transfer or storage, is then consumed by machine learning—using any of a number of suitable algorithms, architectures, and intermediate steps, according to the present embodiment. This input data may be streamed and processed remotely, or operated upon directly on the device, according to some embodiments of the presently described technology, but one representative example would be a stream-rate of once per every few seconds.

This user data—which, when processed within an Automated Confidence Score and Authentication Metrics Framework (“ACSAMF”)—can be used in an accurate way to uniquely identify the source at a user level. This identification is expressed in terms of a personal Confidence Score and authentication metrics. These authentication metrics and Confidence Scores form the basis and determine a user's authentication status or eligibility to be provided or denied to additional third-party goods, services, or private network access. Today, users utilize SCs (username or password, physical key with PIN, cryptographic credentials stored in smartphone, etc.), but the presently disclosed technology authentication creates ever-changing, artificial intelligence-generated, dynamic credentialling. The act of using the presently disclosed technology to gain access in this manner to the sources described is known as performing a “Pahu-In”. For instance, Samantha is a user with a current Pahu Score (also known as a per-user Confidence Score) above a critical threshold, she could use the ACSAMF to Pahu-in to her favorite coffee establishment's app or webpage to place her order without the need for separate, manual authentication—such as the utilization as entering a username and password or typing in the PIN to a key.

The Automated Confidence Score and Authentication Metrics Framework (“ACSAMF”) supports the dynamic creation of a user's digital identity. More specifically, the disclosed technology relates to processing, analyzing and automatically determining the most recent data within the ACSAMF is from the user, where the data is complex and consisting of a plurality of distinct sources. This likelihood expressed in terms of the personal Confidence Score, which is a numeric value ranging between zero (0) and one hundred (100), according to some embodiments of the present disclosure. Therefore, by allowing an always-on authentication (AoA) model versus a point-in-time (PiT) authentication model (most every authentication in use today), the Score is continually updated and forms a running assessment that the user is who they say they are across all points in time. The disclosed technology relates to these additional authentication factors (location, time, other) and is ingested by machine learning algorithms. This analysis can be conducted using computers configured in either a large server or cluster-based architecture, hosted either locally or in the cloud-where it is understood for these purposes that the cloud could be a public or private cloud with a plurality of processing and storage units, and operating with or without a virtual private network. In some embodiments, the processing can include calculating advanced machine learning results and statistical measures associated with the multi-channel user datasets, such as the probability of the input data representing the data on which the machine learning systems was trained.

Embodiments of the presently disclosed subject matter can include a method to continuously load or ingest large datasets and very accurately identify the probability that the incoming data is representative of the specific user's data patterns. Some embodiments of the presently described ACSAMF allow for the calculation of these PCS and authentication metrics for a plurality of users using a multitude of machine learning algorithms and statistical approaches. The systems and methods of the present disclosure leverage AIDC, providing superior usability and security characteristics over the conventional static credentialling (SC), and this continuous process of the present disclosure enables always-on-authentication (AoA), which distinguishes the present systems and methods from the standard point-in-time (PiT) authentication.

Additionally, some embodiments of the presently described ACSAMF allow the user to, through no active user participation with the app, maintain a variable personal confidence score or PCS which, depending on the magnitude, can allow the user to perform an effortless or seamless authentication into disparate third-party networks or systems to access said vendor's goods or services through the vendor systems for enhanced convenience. These networks or systems most often take the form or mobile apps or webpages. Conversely, the PCS may not be of sufficient magnitude to allow for seamless authentication, whereby the ACSAMF can provide additional manners or methods to augment or “Boost” their PCS or temporarily add points to their PCS—through a host of methods such as MFA, SMS text, email, nearby friends verification, biometric scans or potentially-available Pahu scanners or PCS SDK applications residing on TVs, computers, or any digital device.

The presently disclosed technology is a Centrally, User-Managed portable Identity (CUMI) that is ubiquitous. In other words, most authentication constructs such as a username and password, are tied to devices. Today, a device stores the SC and may be invoked or provided when a biometric is approved on that device or other device specific authentications to recall the SC. The cloud may also store these SCs and be invoked, typically through a SC. If a user with SC loses their phone which had multiple log-in credentials to multiple applications, they would need to go into each one of those applications and reset their passwords, today. When utilizing a CUMI, a user can lock all access via the present application, reset all access via a CUMI for all participating applications, and access multiple systems via its use of the CUMI. If a phone is lost or stolen with the present technology, all their accounts can be locked—providing much higher security—according to some embodiments of the present technology. When their new phone arrives, the user may re-establish previous connected accounts via an automatic reset. With today's Siloed Authentication Systems (SAS) there is no way to centrally control access or denial. Each SAS today and most all log ins today are islands to themselves. Each needing to be reset if compromised.

In this instance, and throughout this present disclosure, the term “User Data” refers to any dataset, in any of a multitude of possible formats, which expresses the innate characteristics of the user through direct or peripheral sensors, telemetry and/or application data from the IoT device. Examples of current user data being brought into the ACSAMF: velocity, acceleration, rotation, torque, location, geomagnetic force, rotation, and phone status.

This input dataset may be furnished to the present systems and methods through an application protocol interface (“API”) or similar data streaming connection type. If the dataset has not been previously processed by the ACSAMF, the system will initiate the processing and aggregation 115 step. Otherwise, the system will immediately render the previously processed output to continue the iterative processes of personal confidence score and authentication metrics calculation. The input dataset for each user will naturally vary—as not all smartphone devices contain a common set of sensors or data configurations for sensor data. These data feeds generally contain data consistent with a three-dimensional position, velocity, acceleration, rotation, and magnetic field characterization, although additional data feeds are also common. This is to say that each category given above may be supplied to the ACSAMF as an ordered triplet, representing the X, Y, and Z directional components of the device or the vector magnitude of said components.

In this step 115, the raw data received from the smartphone or other peripheral device, as discussed in below, is processed to apply the machine learning or artificial intelligence methods of step 120. The input data is high frequency or always streaming, time-ordered sensor data—data points for each sensor type or feed are recorded every single microsecond or tens of microseconds. The purpose of 115 is to reduce the frequency of record of the data as well as apply additional transformations. According to some embodiments, one such aggregation is achieved by down sampling—using a statistical representation (mean, median, etc.) of the high-frequency data (raw inputs) with the corresponding lower frequency data. To cite an example, according to one embodiment of the present technology, the millisecond data values for all distinct elements of the data feeds are converted to second-based data values by averaging the 1,000 values of the raw feed by a single mean value. As one skilled in the art may recognize, additional down samplings are possible and thereby achieves an economical way to represent statistical representations of the input data for later processing in step 120. These embodiments can leverage large-scale—or big data—machine learning or artificial intelligence methods relying on rigorous feature engineering, machine learning modeling and model tuning techniques to provide a determination of the PCS and authentication metrics. These flexible and scalable methods achieve a multi-input pattern recognition on the underlying raw and potentially aggregated intermediate user data inputs. A plurality of machine learning models is applied to data of various time-scale resolutions to account for user behavior patterns which occur at distinct timescales. According to some embodiments of the presently disclosed technology, these machine learning algorithms may be applied in a piecemeal fashion to the data. Said in another but equivalent way, they may be applied in layers. These layers may operate on user input data that corresponds to different time scales, or different locations, or both. One representative example of temporal layering in the application of the presently described technology could have three layers of machine learning algorithms, with one layer operating on and characterizing the user behavior of short-term or recent data (possibly the last several hours), one layer operating on a longer time scale (possibly the last several days), and a final layer which operates on even longer term data—which may or may not be aggregated-which could represent user data from the last several months. It is to be understood that the example given is representative in nature, and the currently described technology is not limited to time or location artifacts inherent to any given system of units, such as: “month”, “week”, “day”, “hour”, “minute” or “second”.

For the typical cases, where the data is new to the system, the system executes step 120, and therefore generates the results of step 125, according to FIG. 1. In addition to aggregating the data, the input data 110 may also be additionally transformed to provide a more useful description of the user data behavior patterns. According to some embodiments of the presently disclosed technology, data variables may be constructed from the raw user input data which represent non-numeric values indicating if a value or threshold value has been exceeded, occurred at a certain time of day (expressed in minutes, hours, days, day of the week, etc.) and so forth. As someone skilled in the art will recognize, these transformations a class of operations is referred to as “feature engineering”, and that furthermore, the data resulting from said feature engineering is known as “features”. It is to be understood that any number of mathematical operations can be performed on the input data or the aggregated data resulting from step 115 to produce “features” which improve the machine learning algorithm's ability to accurately identify data coming from the user's device as the belonging to or similarly matching the patterns present in the data that the machine learning algorithm was trained on.

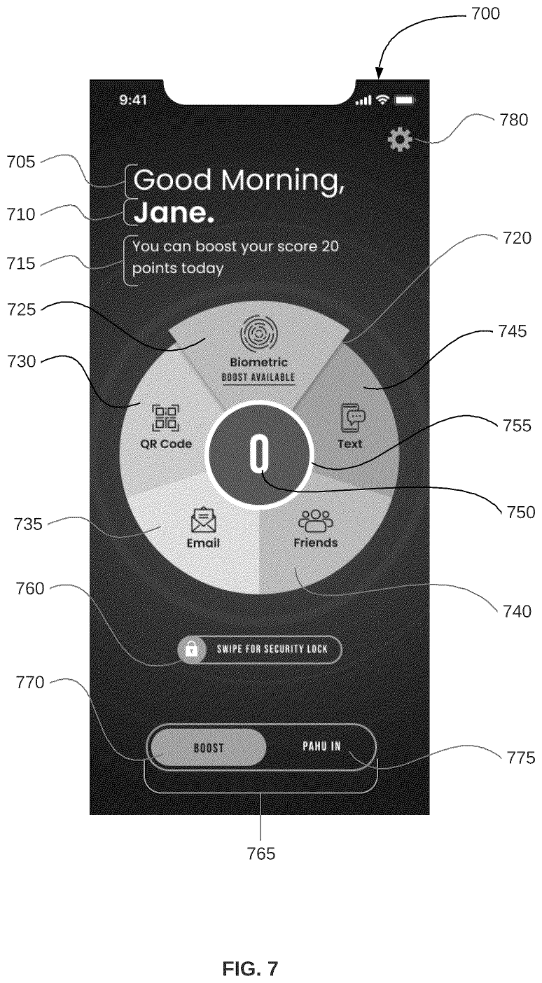

In the simplest conceivable case, a single machine learning model may return a probability ranging from 0-100 that the data introduced to the process 120 is representative of the user's previously processed data. Additional models may be trained on distinct features, including features derived from the step 115 which has been additionally down sampled. In cases such as these, where a plurality of machine learning models or data science techniques are applied, various schemes are employed to combine the resultant probabilities, according to some embodiments. In addition to the previously discussed machine learning probability outputs, additional useful approaches may be applied to the input data (whether raw in nature or aggregated, or both), according to some embodiments of the present technology. Confidence Scores may degrade based upon possible anomalous data (e.g., time-based, or location-based data factors), failed MFA attempts, and other conditions not being met or familiar to the machine learning algorithms. Upon completion of the generation of the confidence scores and authentication metrics 125, outputs from one or more specifically trained machine learning algorithms provides a confidence score which is used as an input into the final score 750 which is to be rendered by the front end 130 as shown in FIG. 7.

Using the identifying characteristics of a user's unique digital behavior patterns, as precisely quantified by machine learning algorithms as either belonging to said user or not—as expressed in precise terms in the form of a personal confidence score and authentication metrics, the presently described systems and methods allows for seamless authentication into third-party networks and services. The GUI (Pahu Mobile Application) described herein allows for unique functionality to allow users to know their own score and using additional information to Boost their score as well as navigate between multiple possible external services. As will be appreciated, such functionalities can be powerful features designed to provide seamless authentication.

According to some embodiments of the present technology, a user's personal confidence score may be, for various reasons-including but not limited to a newer user where less training data is present in the system, a user performing non-typical tasks or actions, a user traveling in a way inconsistent with previously learned behavior, etc.—be lower than the amount required to automatically authenticate into a given system. In these cases, the user may be required to “Boost” their score. These Boosts are discussed in more detail in below and require additional data into the system 100, in step 135. The personalized confidence score and authentication metrics are then used the basis for the decision point 140—namely to grant 150 or deny 155 the user's ability to perform an authentication into a third-party network or service. The iterative process of continually ingesting more data and arriving at a set of personalized confidence scores and authentication metrics 145 is indicated, according to some embodiments of the presently disclosed technology. The process terminates in one iteration 160 after the authentication step.

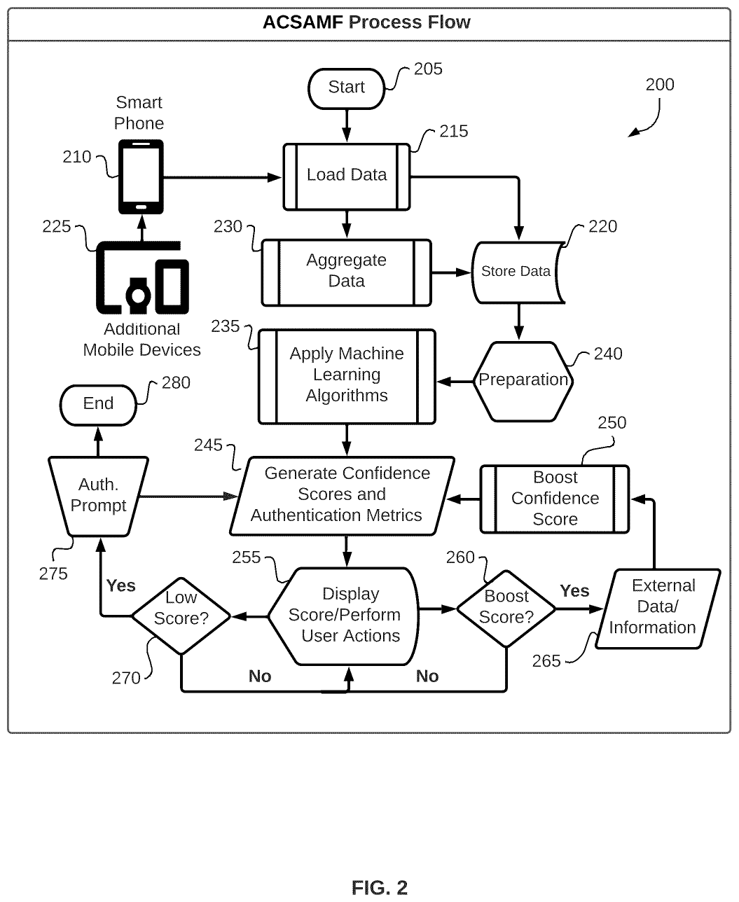

FIG. 2 illustrates an exemplary interaction view 200 in which an embodiment of the disclosed Automated Confidence Score and Authentication Metrics Framework (“ACSAMF”) is realized. FIG. 2 depicts the interplay between user interactions and system processing modules for the primary workflow utilized by the ACSAMF presently described, according to some embodiments of the present disclosure. As summarized in FIG. 1, this image depicts greater detail in the user journey as well as the software architectural aspects of the present system and methods. The process depicted assumes the user is already a signed up for the Pahu service. The process flow initiates 205 with loading data as discussed previously, where it is now understood that the data may be of smartphone 210 origin or other mobile devices 225. This input data is both stored and aggregated 200, and the feature engineering discussed below takes place 240. One or more machine learning techniques are applied to the dataset or datasets, according to some embodiments of the present technology 235, and the outputs 245 are understood from 200 to contain both confidence scores and authentication metrics. This information is relayed to a user interface 255.

The display and graphical user interface allow for a plurality of additional user features, according to some embodiments of the presently disclosed technology. In one embodiment, the user may wish to increase their score 260. As mentioned above, this is known as a Boost. To proceed, additional information or data, either from the device itself 210, or an auxiliary mobile device 225 is processed 250. This action has a material effect on the confidence scores and is redisplayed in the graphical user interface. An additional potential action according to some embodiments could be a system-generated prompt 270, leading to an authentication, which similarly feeds into the 245 process and additionally represents the completion of the ACSAMF process flow, according to some embodiments of the presently disclosed technology. Aspects of the disclosed technology further include methods for displaying the generated variable confidence scores in real time, allowing the user to know ingesting into the disclosed systems additional data large amounts of data from a plurality of sources and formats, performing advanced, custom transformations, and combining the collected and transformed data to facilitate system processing. By applying feature engineering to the raw data, the AI can utilize more unique user data and by using more unique user data the AI is able to increase its accuracy.

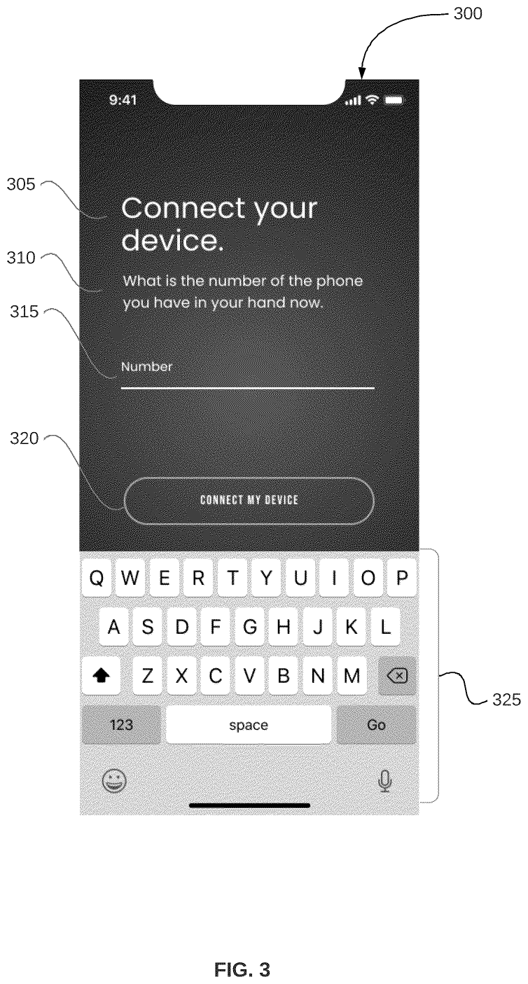

FIG. 3 is a representative depiction of the primary user sign-on interface, showing an instruction/purpose title 305, further detailed instructions 310, a user input field 315, and a user submit button 320, according to some embodiments of the present disclosure. This initial connection interface allows for a connection to the ACSAMF, via a standard mobile input keyboard 325. The systems and methods of the present disclosure can then make these various measures available to a convenient graphical user interface (GUI) for visualization of the resulting scores as well as providing novel interactions by the user. By constantly making the PCS available to the user through the interface, the system can highlight, or emphasize various actions based on the user's input which would results in an increased score. This set of actions whereby the user increases their score for a finite duration of time is known as a Pahu Boost, PCS Boost or simply a Boost. As will be appreciated, aspects of the present disclosure can include additional features not found in conventional approaches, including features which automatically provide authentication alterations in a permuted sense to a selected path which would result in a corresponding change to that path's basic and advanced metrics and measures.

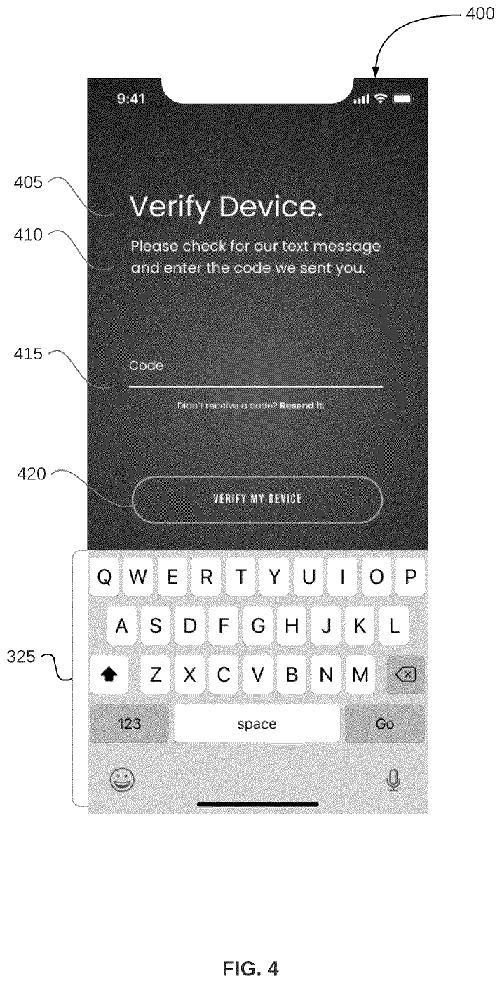

FIG. 4 is an example interface present in some embodiments of the present disclosure, depicting the secondary user sign-on interface, depicting the verification prompt 405, instructions to the user to check their text messages for the verification code sent by the ACSAMF service 410, as well as a user input field 415 and corresponding user submit button 420. As with 300, the standard mobile keyboard representation 325 is the method of code entry of this interface.

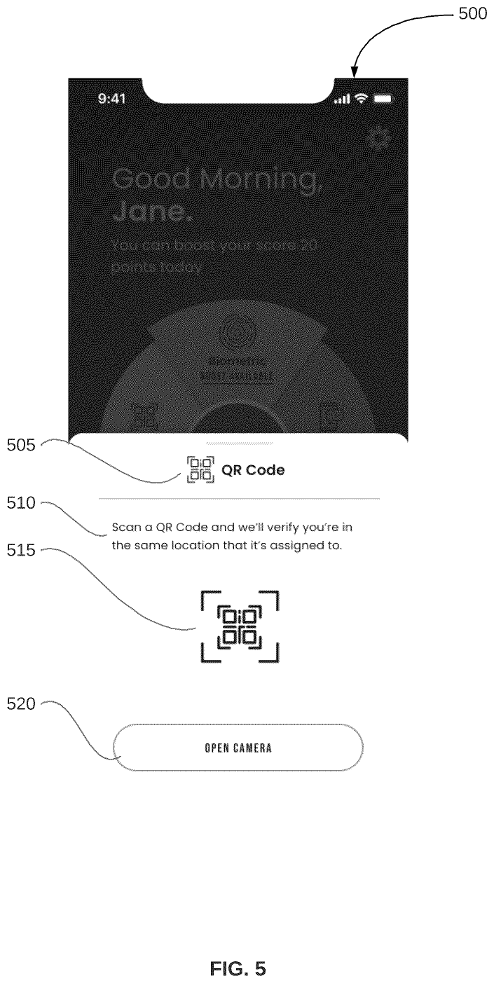

FIG. 5 is an example QR Code entry mobile interface, according to some embodiments of the presently described systems and methods, illustrating the header menu 505, user instructions 510, helpful QR symbol depiction 515, and a user button to open the camera application of the mobile device 520. The purpose of 520 is to facilitate a QR code used for user verification.

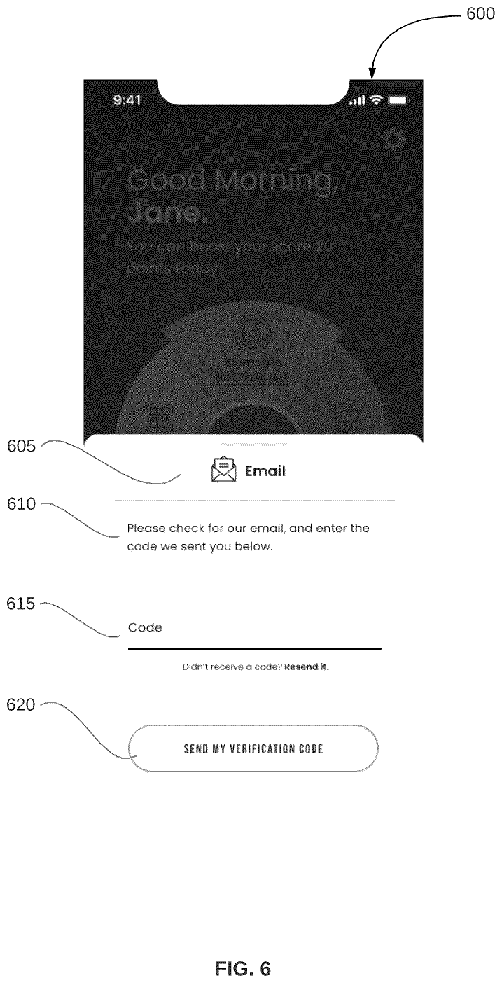

FIG. 6 contains a depiction of the email verification mobile interface, showing the header menu 605, the user instructions panel 610—informing the user to check their email for a verification code, a user-entry field 615 as well as user button to send the verification code to the present device 620, according to some embodiments of the present disclosure. Additional or alternate means of user verification are possible, and the present embodiment is shown for exemplary purposes.

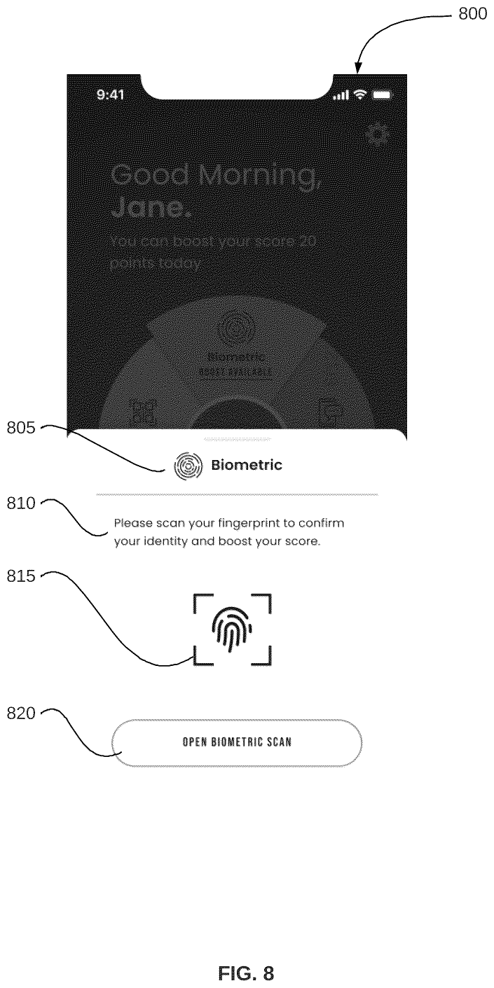

FIG. 7 is a view of the main mobile graphical user interface, showing a personalized greeting 705/710, a Boost message 715, and a round Boost menu 720—containing a host of personal confidence score Boost methods. In this view, according to some embodiments of the present technology, Boost options available to user include a biometric Boost 725—which is currently visually raised as a method of additional emphasis, a QR code Boost 730, and email option 735, a Friend's option 740, and a text Boost. The novel concept of a score Boost is described in greater detail in FIGS. 8-16. As shown in the current figure, when some Boost options are available or recommended, they may be emphasized in a manner such as presenting a raised appearance. In this view, the center of the circle contains the Pahu score 750-as discussed in detail, starting with [0070].

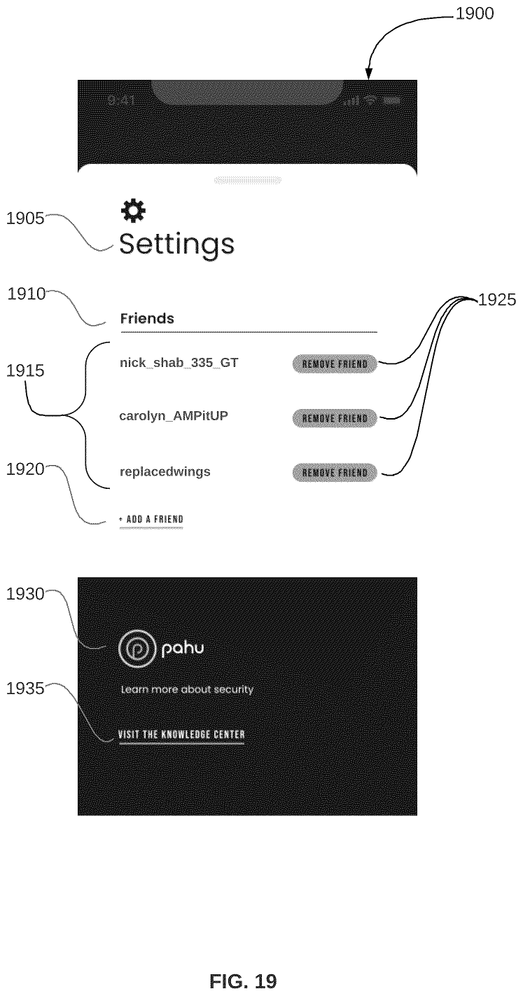

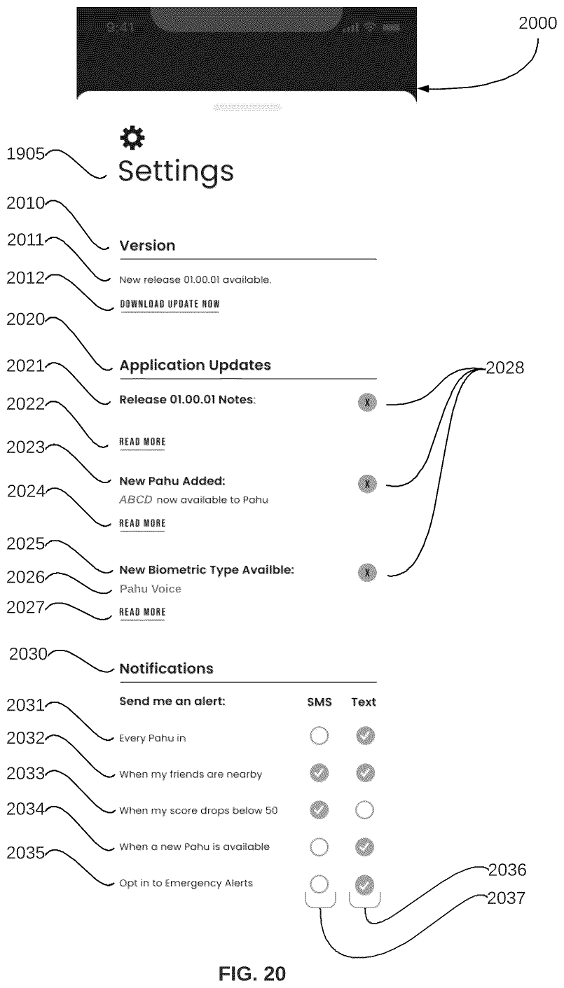

According to some embodiments of the presently described systems and methods, the 750 can be additionally accompanied by visual elements designed to depict or emphasize the current value, such as using color-coding the surrounding ring 755, or the font color. Additional embodiments contain elements designed to depict or emphasize not only the present value of the score, but also the trend—with one such example of the presently described technology using a green background of 750 or font color of 750, or ring 755 color used to indicate an increasing trend of the Pahu score, and red color in the described elements to indicate a decreasing trend in the Pahu score. Is to be understood that additional colors and techniques can be used in lieu of the present examples. The system also provides the user with a secure lock 760 feature, whereby the user is able to swipe to the right on the 760 interfaces to immediately lock out of the main mobile graphical user interface. In addition, 700 depicts a “Boost” 770/“Pahu In” 775 slider 765, according to some embodiments of the presently disclosed technology, allowing the user to either raise their score using the methods and elements, as described previously, or automatically authenticate into a third-party service or network. Also depicted in FIG. 7 is a gear icon 780, giving the user access to the application's personal setting, as shown in FIGS. 19-20.

FIGS. 8-16 show exemplary mobile interfaces associated with Boosting the user's personalized confidence score, according to some embodiments of the disclosed technology.

FIG. 8 is an image of the biometric Boost menu used by the disclosed technology, according to some embodiments. Shown are the menu header 805, the biometric instructions 810, a stylized, simplified fingerprint icon 815, and the user button 820 to initiate the fingerprint scan. The user employs the default biometric devices (if enabled) to manually Boost their Confidence Score. A successful biometric Boost provides the maximum Boosts available.

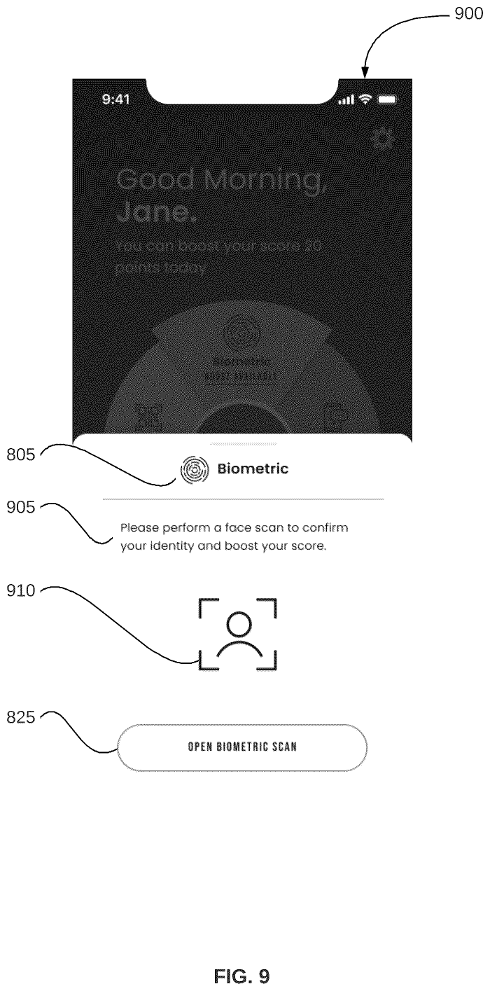

FIG. 9 is an example display of an alternate biometric Boost user interface, according to some embodiments, showing again the menu header 805, instructions for a face scan 905, a simplified, stylized face scan icon 910 and open scan user button 825.

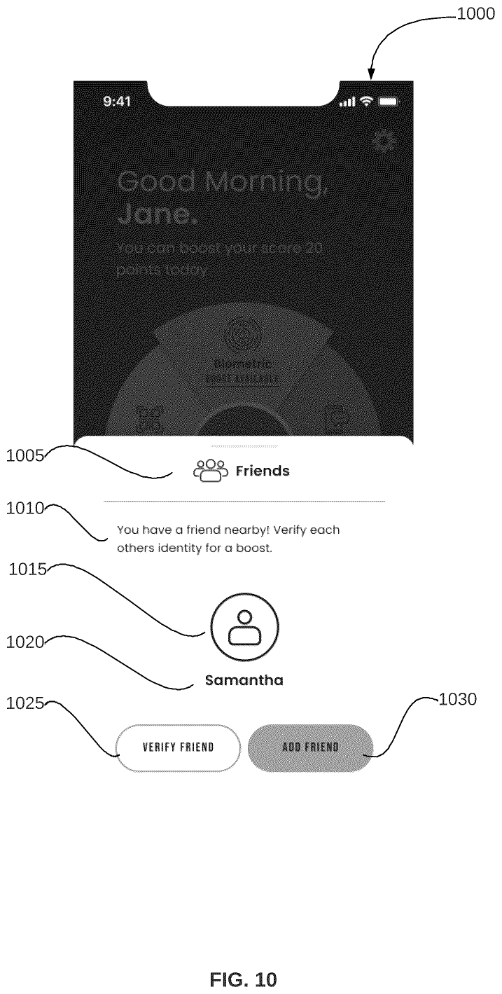

FIG. 10 depicts the Friends Boost menu interface, indicated by the menu header 1005, with a system-generated user notification 1010, an exemplary icon 1015, a friend identifier 1020 and options below to either verify 1025 or add the friend 1030, according to some embodiments. Additional embodiments include a unique peer-to-peer authentication (P2PA) and user verification solution, currently called Friends. Utilizing Bluetooth and/or near field sensor (NFS) application Pahu users can verify another Pahu user is who they say they are, verify a friend is with them and Boost a Confidence Score (peer-to-peer authentication or P2PA). Additionally, because this Friends feature can verify or authenticate additional nearby application users, it may be utilized for personal verification such as at a bank, at a drugstore, on TVs when entering a room without user provocation, or other public areas that a person may not feel comfortable verbally disclosing things like date of birth, full name, social security number etc. According to some embodiments of the present disclosure, this Friends capability also supports the verification of additional aspects of day-to-day life, such as an Uber driver arriving (use of PCS SDK in Uber and P2PA with Pahu user), a babysitter or dog sitter arriving at a home, a bank in taking an application or additional near field authentication scenarios presented in the future. It is an essential element of the systems and methods presented to enable P2PA due to the blending of digital devices and real-world movement of users. It is an essential element of the systems and methods presented that the P2PA does not require a SC.

Other embodiments of the present disclosure include the ability to authenticate or verify both the user of this device, other nearby application users, or a “Pahu reader”—a device which verifies users. This feature is shown and discussed further in the following figure.

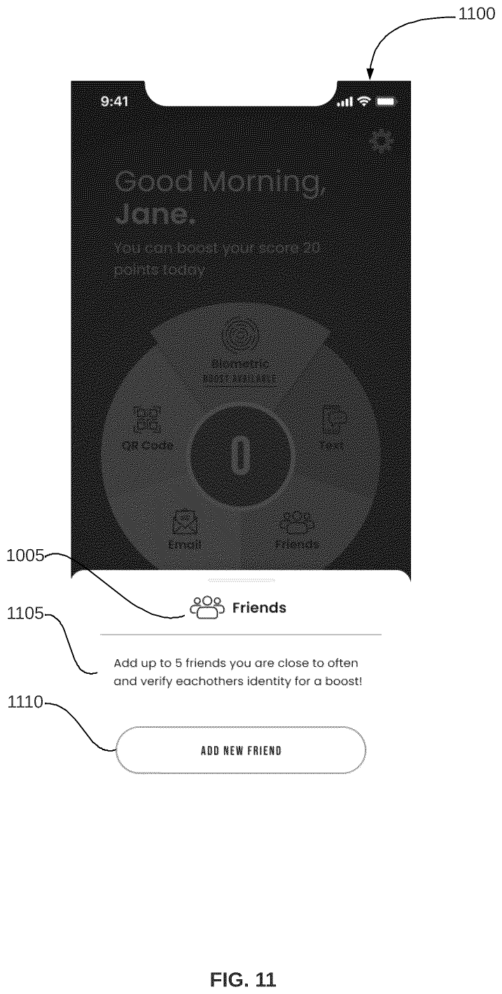

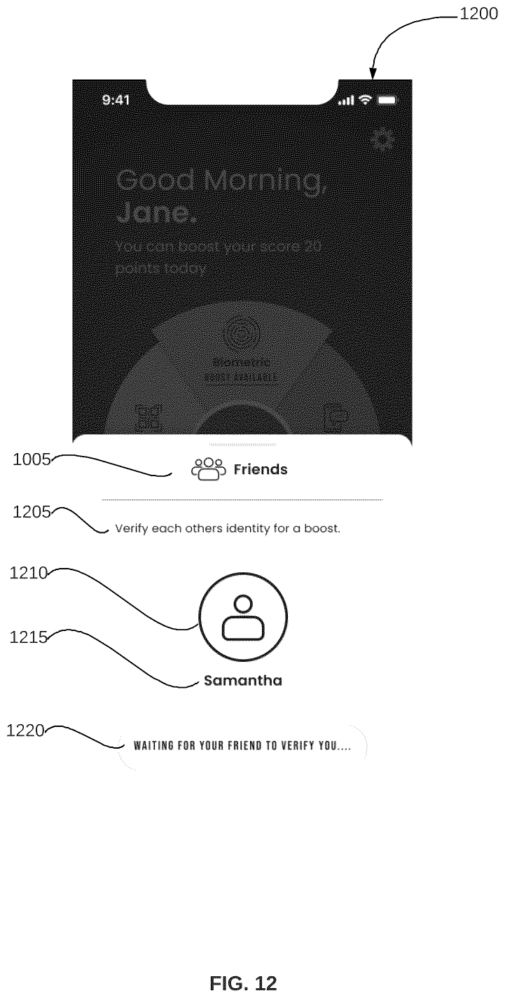

FIG. 11 shows an alternate mobile user interface for adding friends, according to some embodiments of the present disclosure. Depicted in 1100 are the Friend's menu header 1005, the user instructions 1105 and the user button to add new friends 1110. Additional interfaces assist the user in adding friends, and one such interface is shown in FIG. 12.

FIG. 12 is an example of additional steps in adding Pahu Friends, according to some embodiments of the present disclosure. Shown in 1200 are the friends menu header 1005, the user instructions 1205, the general or specific personal icon associated with the friend in question 1210, the friend text identifier 1215, and a button 1220, currently showing the “Waiting for your friend to verify you” message. In these related figures, the given user is first notified of nearby friends to add for a Boost in their score, are presented with a menu to select the nearby mobile user as a friend, and then the two or more nearby users alternatively add and verify each other.

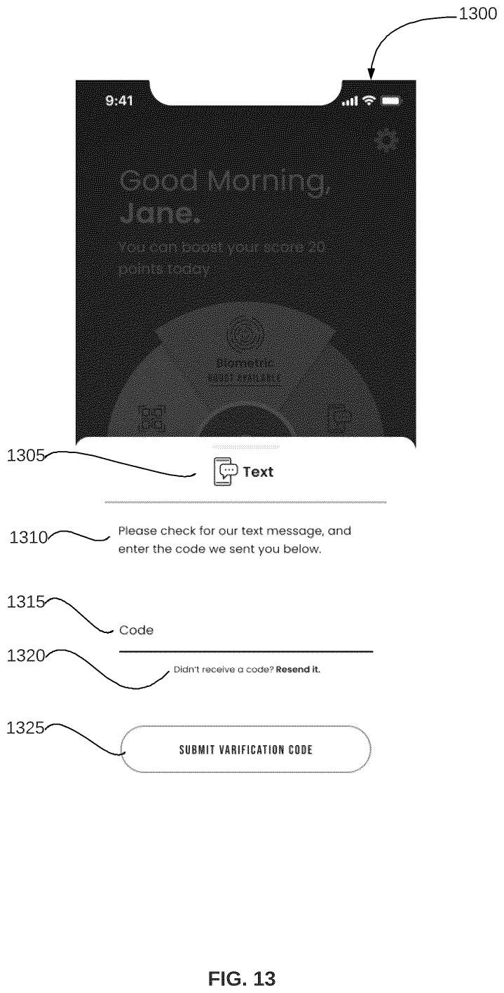

FIG. 13 is an example Text Boost mobile interface, providing the user the option to Boost their Pahu score, according to some embodiments of the present disclosure. This figure contains options like the previous menus, such as a menu header 1305, text instructions 1310, a user entry line 1315, and a user submission button 1325. Additionally, the user is presented with an option to resend the code 1320 if not received, or not entered in time.

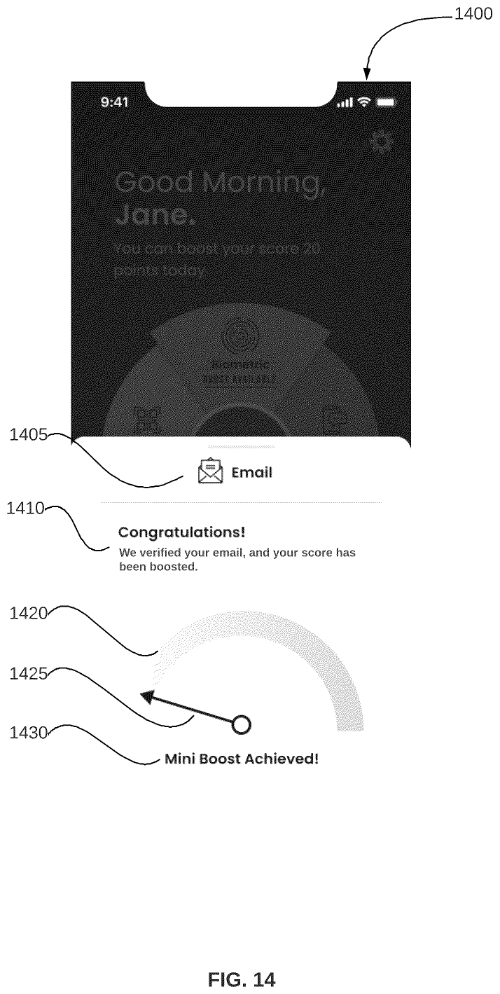

FIGS. 14-16 depict embodiments of various score Boost visualizations, such as the Boost Meter, where it is to be understood that exemplary images are shown but additional visualization techniques could be utilized to convey the concept of a user-based action to increase their own score. Boosts themselves can be based on time-dependent user behavior, and are therefore not static quantities, according to some embodiments of the present disclosure. The score Boost mechanism allows the user to interact with the application and ACSAMF in a “gamified” way. The Boost Meter illustration helps users to understand if a Boost was small or more significant.

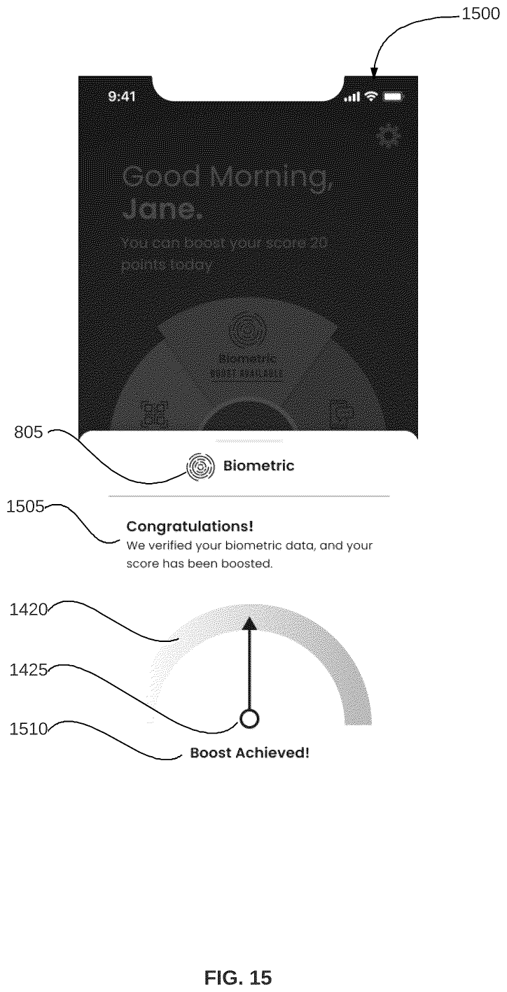

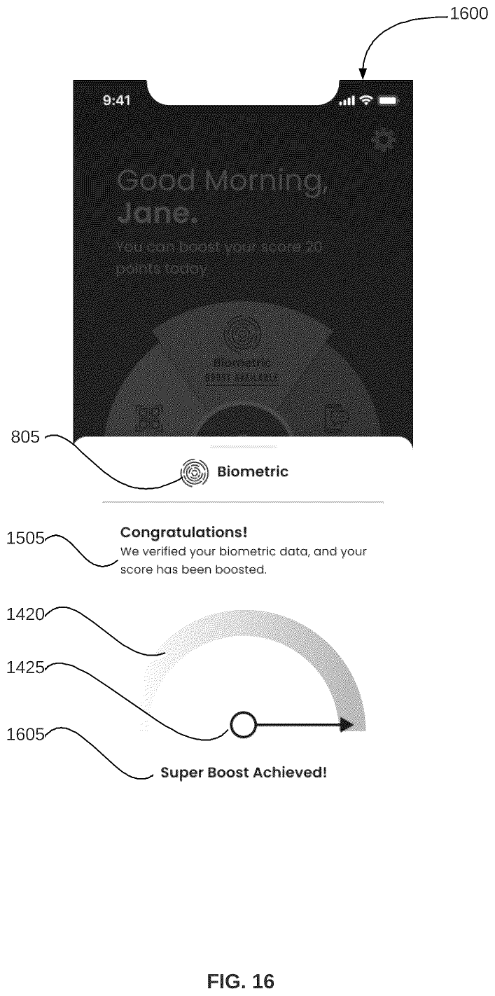

FIG. 14 Shows an exemplary personal confidence score Boost interface, according to some embodiments, corresponding to the Boost achieve in said score when email verification is used. It shows the Email Boost header 1405, a congratulations message 1410, a visual depiction of a Pahu score spectrum 1420, a score indicator 1425 and the Boost quantity message 1430. According to some embodiments, a plurality of score denominations are used, depending on the mechanism of Boost, and are further elaborated upon in FIGS. 15-16.

FIG. 15 is an additional example of a Boost Meter view, according to some embodiments of the present disclosure. FIG. 15 illustrates the biometric Boost interface menu 805, a congratulatory confirmation message 1505, with radial score band 1420 and Boost indicator 1425 as seen in FIG. 14, and Boost quantity message 1510. The score band is now colored green, and together with 1510, it is to be understood, according to some embodiments of the present disclosure, that a larger Boost denomination was achieved via the given biometric method.

FIG. 16 is an alternate embodiment of the biometric Boost interface or Boost Meter of FIG. 15, showing the biometric Boost interface menu 805, the Boost confirmation message 1505, the green score band 1420, and visual Boost indicator 1425, and Boost quantity message 1605. It shows the visual Boost indicator pointing to the maximum value possible, and together with 1605, it is to be understood that the largest Boost possible has been achieved, according to some embodiments of the presently described technology.

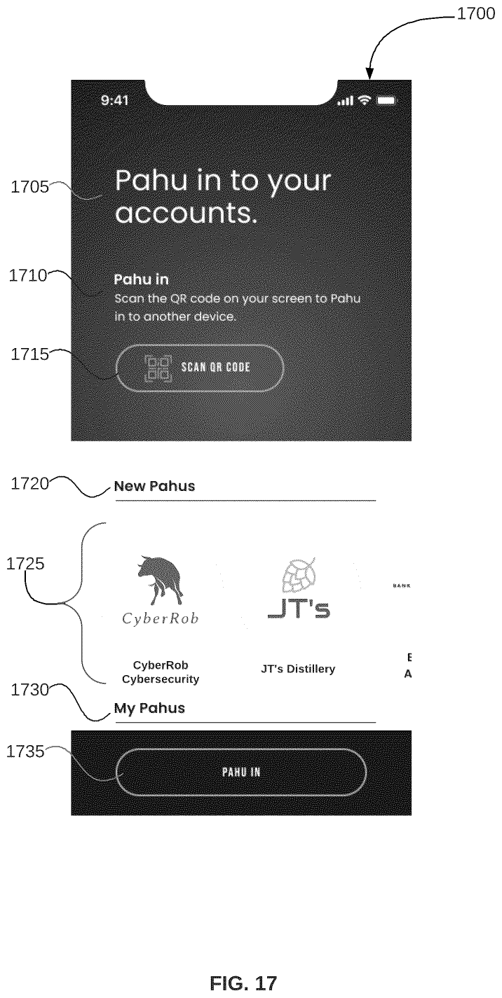

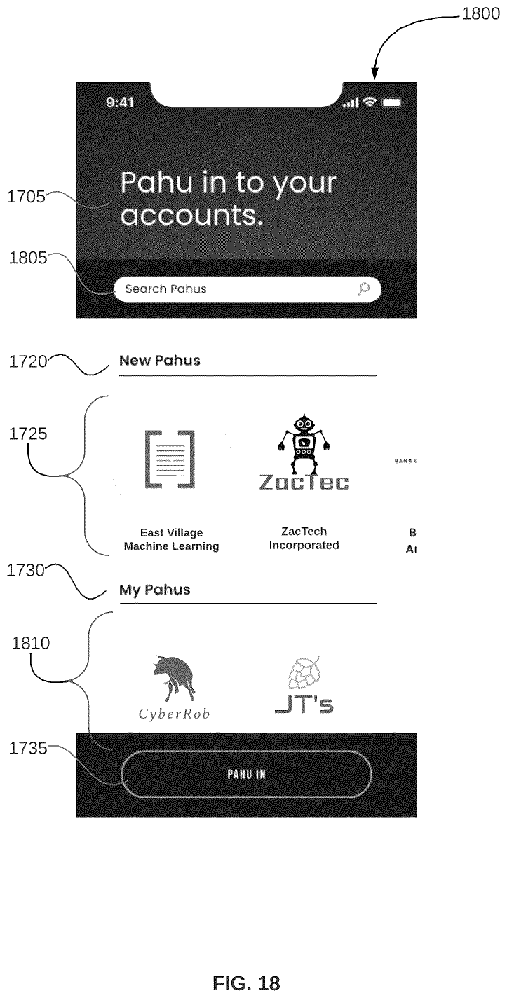

FIG. 17 is a depiction of the “Pahu-in” interface, according to some embodiments of the present technology, that is afforded the user due to Pahu CUMI aspects, which shows both “New Pahus” available to the user but also “My Pahus”, which would be the sites the user Pahus into more frequently. 1700 depicts one embodiment of this functionality including a header message 1705, an instruction message 1710 describing the actions to be taken to scan a QR code to Pahu-in to another device or service, as well as a user button to open the mobile device's camera application to enable the QR code scan. Further illustrated is one layout, according to some embodiment of the present technology to show possible newly added services to Pahu-in to 1720, with specific examples listed 1725, and beneath that is the partially seen listing of older Pahus 1730 to possibly connect to. Once the user selects an existing service to connect to, the user selects the Pahu In button 1735 to enable the automatic authentication, based on their current Pahu score, according to some embodiments. In the user interface of FIGS. 17 and 18, additional options to “Pahu In” would be found, according to some embodiments of the present technology by swiping to the right.

FIG. 18 is a further image of the type of representation shown in FIG. 17 showing three main functionalities, according to some embodiments of the present disclosure. Beneath 1705, a search bar 1805 is shown—where it is understood that one potential way to perform the search is by using the standard mobile keyboard 325. FIG. 18 shows listings of new 1725 and previously established 1810 Pahu connections possible, with the same method to connect 1735 as shown in FIG. 17.

FIG. 19 shows the user-settings menu, accessible by pressing 780, according to some embodiments of the presently disclosed technology. Beneath the heading 1905, it contains a section titled friends 1910, listing Pahu friends of the user 1915, the option to add another friend 1920, or remove a current friend 1925. Below the Pahu icon 1930, which opens a mobile web browser to the Pahu corporate site, according to some embodiments, is a message to the user to learn more about security, and a link 1935 to visit the Pahu knowledge center. The Knowledge Center is a hosting of how-to videos, explanations of Frequently Asked Questions (FAQs), and other learning assets for a user to find out more about how Pahu works, and how they can customize the application.

FIG. 20 is an additional example Settings menu detail, showing various pieces of information about the mobile application and notification settings, according to some embodiments of the present disclosure. The application version header 2010 is the first subsection listed, and the version message 2011 indicates that a new release is currently available to the user. This is followed by the Application Notes section 2020, where this section contains a link to the release notes 2021, a link to read more about the release 2022, a New Pahu Added section 2023—listing any new services, and a link to read more about new Pahus added 2024. Beneath this section is a New Biometric Type Available section 2025, indicating that Pahu Voice is currently available for biometric verification, as well as a link to read more about this biometric type 2027. Also shown along the right side are “X” symbols, which when pressed close or collapse the corresponding information sections, according to some embodiments. The final section of 2000 is a Notifications preferences section 2030, where the user can control which actions or prompts are delivered to the user through the present application. User options here include being notified by SMS 2036 or Text 2037 for each: Pahu in 2031, when friends are nearby 2032, when the user's Pahu score drops below 50 2033, when a new Pahu is available 2034, or to opt into emergency alerts 2035. When finished with 1905, the user may return to the menu depicted in 700 by swiping this settings menu down, according to some embodiments of the presently disclosed technology.

The present systems and methods make use of the standard smartphone camera with quick response (QR) code reading to be able to access a user's accounts on other devices. This Device-to-Device Authentication (D2DA) saves users from remembering or inputting SCs into other devices with other applications. If a user wants to log into a television streaming service, as an example, instead of remembering the SC for each streaming service, they may be able to use the current application to “Pahu In” by the RP serving up a Pahu-QR code and the user invoking the D2DA via the Pahu Mobile Application. If their PCS is high enough to allow access via pre-determined RP thresholds, according to some embodiments, the user scans the QR on the TV from their phone and they are allowed access. This QR approach may be used for computers, televisions or any IoT device in the future and exists today within the system and methods of what is being presented.

The system and method being presented accesses other third-party systems to provide its AIDC PCS via a Pahu Bridge, as described in more detail above. Typically, these third-party systems are Customer Identity and Access Management (CIAM) solutions and are the primary gateway into digital assets via a GUI. RPs employ these CIAMs to prompt users for their SC. Today CIAMs are also employing password-less solutions of various types by unrelated companies, like Auth0 and WebAuthN. These CIAMs also support and serve up MFA such as SMS or emailed codes. To communicate to these CIAMs, the system and methods utilize a Pahu Bridge which communicates with the CIAM via OAuth or OpenID, standards today. The Pahu Bridge also may detail user access, application use and provide the RP with PCSs not just for PiT authentication, but they may take this data, if integrated, constantly to chart users PCS. It should be noted that for CIAMs to deploy password-less solutions they need to redo their underlying user data architecture and schemas as they rely on a password. An illustrative example could be the Auth0 type, even though it supports additional formats such as WebAuthN. These systems and methods rely upon an integration of two accounts, an account created with a phone number and an account created with an email merged, to support truly password-less functionality within the world's largest CIAM, Auth0.

It will be appreciated by those of ordinary skill in the art that, while the forgoing disclosure has been set forth in connection with particular embodiments and examples, the disclosure is not intended to be necessarily so limited, and that numerous other embodiments, examples, uses, modifications and departures from the embodiments, examples and uses described herein are intended to be encompassed by the claims attached hereto. Various features of the disclosure are set forth in the following claims.

1. A computer system for identity verification, comprising:
at least one processor and at least one memory storing computer-executable instructions that, when executed by the at least one processor, cause the computer system to:
collect training data for the artificial neural network, the training data including at least one set of identifying data corresponding to a user, wherein said at least one set of identifying data includes a respective first plurality of identifying metrics obtained or derived from one or more mobile electronic devices associated with the user and an identification confirmation associated with the identifying data;
train the artificial neural network with the training data by identifying from the training data one or more characteristics associated with the user's unique digital behavior patterns, wherein the artificial neural network is trained when the artificial neural network determines a respective output for each identifying data set the corresponds to the identification confirmation corresponding to that identifying data set;
receive, by the artificial neural network, as trained, a user request for an identification confirmation score and a corresponding request data set, said request data set including a second plurality of identifying metrics obtained or derived from one or more mobile electronic devices associated with the user;
process, by the artificial neural network, as trained, the request data set;
determine, by the artificial neural network, as trained, an identification confidence score of the user based on processing the request data set;
and output, by the artificial neural network, as trained, the identification confidence score for the user as determined, wherein said identification confidence score is utilized by a relying party to grant access to a secured online resource.

2. The computer system of claim 1, wherein the computer system is further configured to refine the training of the artificial neural network with the data from the request data set.

3. The computer system of claim 1, wherein the first and second pluralities of identifying metrics are obtained from at least one of a smartphone sensor, telemetry or application data from an IoT device.

4. The computer system of claim 3, wherein the smartphone sensor is selected from the group comprising a magnetometer, a gyroscope, a pressure sensor, a temperature sensor, an accelerometer, a gravity sensor, a latitude and longitude sensor, position sensor and a geomagnetic force sensor.

5. The computer system of claim 1, wherein the artificial neural network is cloud-based and the respective data sets are processed remotely in the cloud.

6. The computer system of claim 1, wherein the artificial neural network is locally stored and the respective data sets are operated upon directly on the user's mobile electronic device.

7. The computer system of claim 1, wherein the system is continuously collecting training data and continuously retraining the artificial neural network.

8. The computer system of claim 1, wherein the operation of the system requires no active user participation.

9. The computer system of claim 1, wherein the identification confidence score may be increased by the user by a method selected from the group comprising: Multi-Factor Authentication, an SMS text, an email, verification from a nearby friend, verification by a nearby device and a biometric scan.

10. The computer system of claim 1, wherein the training data set and the request data set use down sampling of high frequency data.

11. A method of identity verification comprising:
collecting training data for an artificial neural network, the training data including at least one set of identifying data corresponding to a user, wherein said at least one set of identifying data includes a respective first plurality of identifying metrics obtained or derived from one or more mobile electronic devices associated with the user and an identification confirmation associated with the identifying data;
training the artificial neural network with the training data by identifying from the training data one or more characteristics associated with the user's unique digital behavior patterns, wherein the artificial neural network is trained when the artificial neural network determines a respective output for each identifying data set the corresponds to the identification confirmation corresponding to that identifying data set;
receiving, by the artificial neural network, as trained, a user request for an identification confirmation score and a corresponding request data set, said request data set including a second plurality of identifying metrics obtained or derived from one or more mobile electronic devices associated with the user;
processing, by the artificial neural network, as trained, the request data set;
determining, by the artificial neural network, as trained, an identification confidence score of the user based on processing the request data set;
and outputting, by the artificial neural network, as trained, the identification confidence score for the user as determined,
wherein said identification confidence score is utilized by a relying party to grant access to a secured online resource.

12. The method of claim 11, further comprising refining the training of the artificial neural network with the data from the request data set.

13. The method of claim 11, wherein the first and second pluralities of identifying metrics are obtained from at least one of a smartphone sensor, telemetry or application data from an IoT device.

14. The method of claim 13, wherein the smartphone sensor is selected from the group comprising a magnetometer, a gyroscope, a pressure sensor, a temperature sensor, an accelerometer, a gravity sensor, a latitude and longitude sensor, position sensor and a geomagnetic force sensor.

15. The method of claim 11, wherein the artificial neural network is cloud-based and the respective data sets are processed remotely in the cloud.

16. The method of claim 11, wherein the artificial neural network is locally stored and the respective data sets are operated upon directly on the user's mobile electronic device.

17. The method of claim 11, wherein the steps of collecting training data and training the artificial neural network occur continuously.

18. The method of claim 11, wherein the method requires no active user participation.

19. The method of claim 11, wherein the identification confidence score may be increased by the user by a method selected from the group comprising: Multi-Factor Authentication, an SMS text, an email, verification from a nearby friend, verification by a nearby device and a biometric scan.

20. The method of claim 11, wherein the training data set and the request data set use down sampling of high frequency data.
